(19) United States
(12) Patent Application Publication
(10) Pub. No.: US 2015/0097138 A1
(43) Pub. Date: Apr. 9, 2015

(54) Thermally Conductive Silicone Composition

(71) Applicant: Dow Corning Toray Co., Ltd., Tokyo (JP)

(72) Inventors: Tomoko Kato, Ichihara-shi (JP); Kazumi Nakayoshi, Sodegaura-shi (JP)

(21) Appl. No.: 14/384,419

(22) PCT Filed: Mar. 8, 2013
(86) PCT No.: PCT/JP2013/057327

§ 371 Date: Sep. 11, 2014

(30) Foreign Application Priority Data
Mar. 12, 2012 (JP) 2012-054887

(51) Int. Cl. C09K 5/14

(52) U.S. Cl. CPC C09K 5/14
USPC 252/75

(57) ABSTRACT

A thermally conductive silicone composition comprising: (A) an organopolysiloxane that is liquid at 25° C. and preferably has a viscosity of from 100 to 1,000,000 mPa·s; (B) an aluminum oxide powder having an average particle size of not more than 10 μm and preferably from 1 to 8 μm; and (C) an aluminum hydroxide powder having an average particle size of greater than 10 μm and preferably not greater than 50 μm, has low thixotropy, low specific gravity, and high thermal conductivity.

### TECHNICAL FIELD

The present invention relates to a thermally conductive silicone composition.

Priority is claimed on Japanese Patent Application No. 2012-054887, filed on Mar. 12, 2012, the content of which is incorporated herein by reference.

### BACKGROUND ART

Following an increase in a package density and integration density of printed circuit boards and hybrid ICs on which transistors, ICs, memory elements, and other electronic parts are mounted, thermally conductive silicone compositions are used in order to effectively dissipate heat. For example, as such a thermally conductive silicone composition, Japanese Unexamined Patent Application Publication No. H05-140456 describes a thermally conductive silicone rubber composition comprising: an organopolysiloxane, an aluminum hydroxide powder having an average particle size of not more than 10 μm, an aluminum oxide powder, platinum or a platinum compound, and a curing agent; Japanese Unexamined Patent Application Publication No. 2010-100665 describes a thermally conductive silicone grease composition comprising: an aluminum hydroxide powder mixture having an average particle size (post-mixed) of 1 to 15 μm that includes an aluminum hydroxide powder having an average particle size of 0.5 to 5 μm and an aluminum hydroxide powder having an average particle size of 6 to 20 μm, an organopolysiloxane, and an aluminum oxide powder having an average particle size of 0.5 to 100 μm; Japanese Unexamined Patent Application Publication No. 2011-089079 describes a thermally conductive silicone composition comprising: an organopolysiloxane having at least two alkenyl groups in a molecule, an organopolysiloxane having at least two silicon-bonded hydrogen atoms in a molecule, a thermally conductive filler constituted by not less than 70 mass % of an aluminum hydroxide powder, and a platinum-based catalyst; and Japanese Unexamined Patent Application Publication No. 2011-178821 describes a thermally conductive silicone composition comprising: an organopolysiloxane having at least two alkenyl groups in a molecule, an organopolysiloxane having at least two silicon-bonded hydrogen atoms in a molecule, a thermally conductive filler wherein not less than 25 mass % of the total parts by mass of the thermally conductive filler is constituted by an aluminum oxide powder and not less than 60 mass % of the thermally conductive filler is constituted by an aluminum hydroxide powder, and a platinum-based catalyst.

However, the documents above do not specifically recite a thermally conductive silicone composition comprising: an aluminum hydroxide powder having an average particle size of greater than 10 μm and an aluminum oxide powder having an average particle size of 10 μm or less. Additionally, the thermally conductive silicone compositions recited in the documents above have high thixotropy and, as a result, there is a problem in that fluidity is poor.

An object of the present invention is to provide a thermally conductive silicone composition having low thixotropy, low specific gravity, and high thermal conductivity.

### DISCLOSURE OF INVENTION

The thermally conductive silicone composition of the present invention characteristically comprises:

(A) 100 parts by mass of an organopolysiloxane that is liquid at 25° C.;
(B) from 50 to 600 parts by mass of an aluminum oxide powder having an average particle size of not more than 10 μm; and
(C) from 100 to 500 parts by mass of an aluminum hydroxide powder having an average particle size of greater than 10 μm.

### EFFECTS OF INVENTION

The thermally conductive silicone composition of the present invention has low thixotropy, low specific gravity, and excellent thermal conductivity.

### DETAILED DESCRIPTION OF THE INVENTION

A detailed description of the thermally conductive silicone composition of the present invention is given below.

Component (A) is an organopolysiloxane that is liquid at 25° C. and is a base component of the present composition. Examples of a group bonded to the silicon atom in the component (A) include methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, and similar straight alkyl groups; isopropyl, t-butyl, isobutyl, 2-methylundecyl, 1-hexylheptyl, and similar branched alkyl groups; cyclopentyl, cyclohexyl, cyclododecyl, and similar cyclic alkyl groups; vinyl, allyl, butenyl, pentenyl, hexenyl, and similar alkenyl groups; phenyl, tolyl, xylyl, and similar aryl groups; benzyl, phenethyl, 2-(2,4,6-trimethylphenyl)propyl, and similar aralkyl groups; 3,3,3-trifluoropropyl, 3-chloropropyl, and similar halogen-substituted alkyl groups; and similar unsubstituted or halogen-substituted monovalent hydrocarbon groups; a small amount of hydroxyl group; and methoxy, ethoxy, and similar alkoxy groups. Of these, the alkyl groups, the alkenyl groups, and the aryl groups are preferable; and methyl, vinyl, and phenyl groups are more preferable.

The molecular structure of component (A) described above is not limited and, for example, may have a straight, branched, partially branched straight, or dendritic molecular structure, of which the straight and partially branched straight molecular structures are preferable. Component (A) may be a single polymer having these molecular structures, a copolymer having these molecular structures, or a combination of these polymers.

Additionally, a viscosity of component (A) is not limited provided that component (A) is liquid at 25° C. From the perspectives of oil bleeding from the present composition being able to be suppressed and handling/workability of the present composition being able to be enhanced, the viscosity of component (A) at 25° C. is preferably in a range from 100 to 1,000,000 mPa·s, more preferably in a range from 200 to 1,000,000 mPa·s, even more preferably in a range from 200 to 500,000 mPa·s, and yet even more preferably in a range from 300 to 100,000 mPa·s.

Examples of the component (A) include a dimethylpolysiloxane capped at both molecular terminals with trimethylsiloxy groups, a dimethylpolysiloxane capped at both molecular terminals with dimethylvinylsiloxy groups, a dimethylpolysiloxane capped at both molecular terminals with methylphenylvinylsiloxy groups, a copolymer of dimethylsiloxane and methylphenylsiloxane capped at both molecular terminals with trimethylsiloxy groups, a copolymer of dimethylsiloxane and methylphenylsiloxane capped at both molecular terminals with dimethylvinylsiloxy groups, a copolymer of dimethylsiloxane and methylvinylsiloxane capped at both molecular terminals with trimethylsiloxy groups, a copolymer of dimethylsiloxane and methylvinylsiloxane capped at both molecular terminals with dimethylvinylsiloxy groups, a methyl(3,3,3-trifluoropropyl)polysiloxane capped at both molecular terminals with dimethylvinylsiloxy groups, a copolymer of dimethylsiloxane and methylvinylsiloxane capped at both molecular terminals with silanol groups, a dimethylpolysiloxane capped at both molecular terminals with silanol groups, a copolymer of dimethylsiloxane and methylphenylsiloxane capped at both molecular terminals with silanol groups, an organopolysiloxane consisting of a siloxane unit represented by the formula: CH₃SiO_{3/2} and a siloxane unit represented by the formula: (CH₃)₂SiO_{2/2}, an organopolysiloxane consisting of a siloxane unit represented by the formula: C₆H₅SiO_{3/2} and a siloxane unit represented by the formula: (CH₃)₂SiO_{2/2}, an organopolysiloxane consisting of a siloxane unit represented by the formula: (CH₃)₃SiO_{1/2}, a siloxane unit represented by the formula: CH₃SiO_{3/2}, and a siloxane unit represented by the formula: (CH₃)₂SiO_{2/2}, an organopolysiloxane consisting of a siloxane unit represented by the formula: (CH₃)₃SiO_{1/2}, a siloxane unit represented by the formula: (CH₃)₂(CH₂═CH)SiO_{1/2}, a siloxane unit represented by the formula CH₃SiO_{3/2}, and a siloxane unit represented by the formula: (CH₃)₂SiO_{2/2}; and combinations of two or more thereof.

Component (B) is an aluminum oxide powder for imparting thermal conductivity to the present composition. An average particle size of component (B) is not more than 10 μm and, from the perspective of further enhancing the handling/workability of the present composition, is preferably in a range from 1 to 8 μm. The form of component (B) is not limited and may be crushed, rounded, or spherical.

From the perspective of enhancing the thermal conductivity and the handling/workability of the present composition, a content of component (B) is in a range from 50 to 600 parts by mass per 100 parts by mass of component (A).

Component (C) is an aluminum hydroxide powder having an average particle size greater than 10 μm for imparting thermal conductivity to the present composition and for lowering the specific gravity of the present composition. From the perspectives of further enhancing the handling/workability of the present composition and further suppressing the thixotropy of the present composition, the average particle size of component (C) is preferably greater than 10 μM and not greater than 50 μm. The form of component (C) is not limited and may be crushed, rounded, or spherical.

From the perspective of enhancing the thermal conductivity and the handling/workability of the present composition, a content of component (C) is in a range from 100 to 500 parts by mass and preferably in a range from 100 to 400 parts by mass per 100 parts by mass of component (A).

Provided that the object of the present invention is not obstructed, the present composition may also comprise (D) an alkoxysilane as an optional component. Component (D) is a component for highly filling component (B) and component (C) without lowering the handling/workability of the present composition. Examples of component (D) include methyl trimethoxysilane, methyl triethoxysilane, dimethyl dimethoxysilane, ethyl trimethoxysilane, ethyl triethoxysilane, hexyl trimethoxysilane, heptyl trimethoxysilane, octyl trimethoxysilane, vinyl trimethoxysilane, and allyl trimethoxysilane.

In cases where a large amount of component (B) and component (C) are compounded, from the perspective that the handling/workability and the heat resistant properties of the present composition will not decline, a content of component (D) is preferably from 1 to 100 parts by mass and more preferably from 3 to 50 parts by mass per 100 parts by mass of component (A).

Furthermore, provided that the object of the present invention is not obstructed, the present composition may also comprise (E) a silica-based filler as an optional component. Examples of component (E) include fumed silica, fused silica, precipitated silica, and similar silica fine powders; and these silica fine powders where a surface thereof is subjected to hydrophobization-treatment by an alkoxysilane, a chlorosilane, a silazane, or a similar organosilicon compound. A BET specific surface area of component (E) is not limited but, from the perspective of further suppressing precipitation/separation of component (B) and component (C), is preferably not less than 50 m²/g and more preferably is not less than 100 m²/g.

From the perspectives of being able to suppress precipitation/separation of component (B) and component (C) and also suppress significant increases in the viscosity of the present composition even in cases where the viscosity of the present composition is low, a content of component (E) is preferably in a range from 1 to 50 parts by mass, more preferably in a range from 1 to 30 parts by mass, and even more preferably in a range from 1 to 15 parts by mass per 100 parts by mass of component (A).

In the present composition, in cases where the organopolysiloxane of component (A) has at least two alkenyl groups in a molecule, a crosslinking agent may be compounded in the present composition, resulting in crosslinking or an increase in viscosity as a result of the hydrosilylation reaction. Examples of the crosslinking agent include: (F) an organopolysiloxane having at least two silicon-bonded hydrogen atoms in a molecule and (G) a platinum-based catalyst.

The organopolysiloxane of component (F) has at least two silicon-bonded hydrogen atoms in a molecule. Examples of a group bonded to the silicon atom other than the hydrogen atom in component (F) include methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, and similar straight alkyl groups; isopropyl, t-butyl, isobutyl, 2-methylundecyl, 1-hexylheptyl, and similar branched alkyl groups; cyclopentyl, cyclohexyl, cyclododecyl, and similar cyclic alkyl groups; phenyl, tolyl, xylyl, and similar aryl groups; benzyl, phenethyl, 2-(2,4,6-trimethylphenyl)propyl, and similar aralkyl groups; 3,3,3-trifluoropropyl, 3-chloropropyl, and similar halogen-substituted alkyl groups; and similar unsubstituted or halogen-substituted monovalent hydrocarbon groups free of unsaturated aliphatic bonds. Of these, the alkyl groups and the aryl groups are preferable, and methyl and phenyl groups are more preferable. Component (F) may have a straight, branched, cyclic, net-like, or a partially branched straight chain molecular structure, of which the straight chain molecular structure is preferable. A viscosity of component (F) at 25° C. is preferably in a range from 1 to 500,000 mPa·s, and more preferably in a range from 5 to 100,000 mPa·s.

Examples of the component (F) include a methylhydrogenpolysiloxane capped at both molecular terminals with trimethylsiloxy groups, a copolymer of dimethylsiloxane and methylhydrogensiloxane capped at both molecular terminals with trimethylsiloxy groups, a copolymer of dimethylsiloxane, methylhydrogensiloxane, and methylphenylsiloxane capped at both molecular terminals with trimethylsiloxy groups, a dimethylpolysiloxane capped at both molecular terminals with dimethylhydrogensiloxy groups, a copolymer of dimethylsiloxane and methylphenylsiloxane copolymer capped at both molecular terminals with dimethylhydrogensiloxy groups, a methylphenylpolysiloxane capped at both molecular terminals with dimethylhydrogensiloxy groups, an organopolysiloxane consisting of a siloxane unit represented by the formula: (CH₃)₃SiO_{1/2}, a siloxane unit represented by the formula: (CH₃)₂HSiO_{/2}, and a siloxane unit represented by the formula: SiO_{4/2}, an organopolysiloxane consisting of a siloxane unit represented by the formula: (CH₃)₂HSiO_{1/2} and a siloxane unit represented by the formula: SiO_{4/2}, an organopolysiloxane consisting of a siloxane unit represented by the formula: (CH₃)HSiO_{2/2}, and a siloxane unit represented by the formula: (CH₃)SiO_{3/2}, and combinations of two or more thereof.

A content of component (F) is such that the silicon-bonded hydrogen atoms in component (F) per 1 mole of the alkenyl groups in component (A) is in a range from 0.1 to 10 moles and preferably in a range from 0.5 to 5 moles.

The platinum-based catalyst of component (G) is a catalyst that accelerates the hydrosilylation reaction. Examples of component (G) include fine platinum powder, platinum black, fine platinum-carrying silica powder, fine platinum-carrying activated carbon, chloroplatinic acid, platinum tetrachloride, an alcoholic solution of chloroplatinic acid, an olefin complex of platinum, and an alkenylsiloxane complex of platinum.

A content of component (G) is a catalytic amount and, specifically, component (G) is preferably used in such an amount that, in terms of mass units, the content of platinum metal in component (G) is in a range from 0.1 to 500 ppm, and more preferably in a range from 1 to 50 ppm in component (A).

Furthermore, a reaction inhibitor may be included in order to enhance the storage stability and the handling/workability of the composition comprising the crosslinking agent described above. Examples of the reaction inhibitor include 3-methyl-1-butyn-3-ol, 3,5-dimethyl-1-hexen-3-ol, 3-phenyl-1-butyn-3-ol, and similar alkyne alcohols; 3-methyl-3-penten-1-yne, 3,5-dimethyl-3-hexen-1-yne, and similar en-yne compounds; and 1,3,5,7-tetramethyl-1,3,5,7-tetravinylcyclotetrasiloxane, 1,3,5,7-tetramethyl-1,3,5,7-tetrahexenylcyclotetrasiloxane, and benzotriazole. A content of the reaction inhibitor is not limited, but is preferably in a range from 10 to 50,000 ppm, in terms of mass units, in the present composition.

Furthermore, provided that the object of the present invention is not obstructed, the present composition may comprise other optional components. Examples thereof include magnesium oxide, titanium oxide, beryllium oxide, and similar metal oxides other than aluminum oxide; magnesium hydroxide and similar metal hydroxides other than aluminum hydroxide; aluminum nitride, silicon nitride, boron nitride, and similar nitrides; boron carbide, titanium carbide, silicon carbide, and similar carbides; graphites; aluminum, copper, nickel, silver, and similar metals; thermally conductive fillers formed from a mixture thereof; and pigments, dyes, fluorescence dyes, heat resistant additives, flame resistance imparting agents other than triazole-based compounds, and plasticizers.

### EXAMPLES

A detailed description of the thermally conductive silicone composition of the present invention is given below using examples. Note that the characteristics recited in the examples are values taken at 25° C. Additionally, the characteristics of the thermally conductive silicone composition were measured as follows.

### [Hardness of Silicone Rubber]

A thermally conductive silicone rubber was fabricated by heating a thermally conductive silicone rubber composition at 150° C. for one hour. The hardness of the silicone rubber was measured using a type A durometer in accordance with the stipulations recited in JIS K 6253-1997 (hardness testing method for rubber, vulcanized and thermoplastic).

### [Viscosity and Thixotropy of Thermally Conductive Silicone Composition]

The viscosity of the thermally conductive silicone composition was measured using a rheometer (AR550, manufactured by TA Instruments). For the geometry, a parallel plate having a diameter of 20 mm was used. The gap was 200 μm and the shear rate was 10.0 (1/s). Additionally, thixotropy was shown as a ratio of the viscosity measured at a shear rate of 10.0 (1/s) to the viscosity measured at a shear rate of 2.0 (1/s).

### [Thermal Conductivity of Thermally Conductive Silicone Composition]

A 60 mm×150 mm×25 mm container was filled with the thermally conductive silicone composition. Following degassing, the surface of the silicone composition was covered with a polyvinylidene chloride film having a thickness of 10 μm. Thereafter, the thermal conductivity of the thermally conductive silicone composition through the film was measured using a quick thermal conductivity meter (QTM-500, manufactured by Kyoto Electronics Manufacturing Co., Ltd.).

### [Specific Gravity of Thermally Conductive Silicone Composition]

The specific gravity of the thermally conductive silicone composition was measured in accordance with the stipulations recited in JIS K 6220-1:2001 (Rubber compounding ingredients—Test Methods-).

### Practical Example 1

100 parts by mass of a dimethylpolysiloxane capped at both molecular terminals with dimethylvinylsiloxy groups having a viscosity at 25° C. of 400 mPa·s, 220 parts by mass of an aluminum oxide powder having an average particle size of 2 μm, 220 parts by mass of an aluminum hydroxide powder having an average particle size of 18 μm, and 3 parts by mass of methyl trimethoxysilane were premixed for 30 minutes at room temperature and, thereafter, heated/mixed at 150° C. for 60 minutes under reduced pressure. Then, the mixture was cooled to room temperature. Thus, a thermally conductive silicone grease composition was prepared. Characteristics of this thermally conductive silicone grease composition are shown in Table 1.

### Practical Example 2

100 parts by mass of a dimethylpolysiloxane capped at both molecular terminals with dimethylvinylsiloxy groups having a viscosity at 25° C. of 400 mPa·s, 220 parts by mass of an aluminum oxide powder having an average particle size of 2 μm, 220 parts by mass of an aluminum hydroxide powder having an average particle size of 18 μm, and 3 parts by mass of methyl trimethoxysilane were premixed for 30 minutes at room temperature and, thereafter, heated/mixed at 150° C. for 60 minutes under reduced pressure. Then, the mixture was cooled to room temperature. Thus, a silicone rubber base was prepared.

Next, 1.0 parts by mass of a copolymer of dimethylsiloxane and methylhydrogensiloxane capped at both molecular terminals with trimethylsiloxy groups having a viscosity of 5 mPa·s (in an amount such that the amount of silicon-bonded hydrogen atoms in this component, per 1 mole of the vinyl groups in the dimethylpolysiloxane included in the silicone rubber base, is 0.9 moles), 0.3 parts by mass of 2-phenyl-3-butyn-2-ol, and a 1,3-divinyltetramethyl disiloxane platinum complex (in an amount such that the platinum metal in this component is, in terms of mass units, 10 ppm in the dimethylpolysiloxane included in the silicone rubber base) were added to the silicone rubber base described above. Then, the mixture was mixed uniformly at room temperature. Thus, a thermally conductive silicone rubber composition was prepared. Characteristics of the thermally conductive silicone rubber composition and the thermally conductive silicone rubber are shown in Table 1.

### Practical Example 3

100 parts by mass of a dimethylpolysiloxane capped at both molecular terminals with dimethylvinylsiloxy groups having a viscosity at 25° C. of 400 mPa·s, 280 parts by mass of an aluminum oxide powder having an average particle size of 2 μm, 115 parts by mass of an aluminum hydroxide powder having an average particle size of 18 μm, 10 parts by mass of fumed silica where a surface thereof is hydrophobization-treated with hexamethyldisilazane and a BET specific surface area is 200 m²/g, and 30 parts by mass of methyl trimethoxysilane were premixed for 30 minutes at room temperature and, thereafter, heated/mixed at 150° C. for 60 minutes under reduced pressure. Then, the mixture was cooled to room temperature. Thus, a silicone rubber base was prepared.

Next, 9.0 parts by mass of a copolymer of dimethylsiloxane and methyl hydrogen siloxane capped at both molecular terminals with trimethylsiloxy groups having a viscosity of 20 mPa·s (in an amount such that the amount of silicon-bonded hydrogen atoms in this component, per 1 mole of the vinyl groups in the dimethylpolysiloxane included in the silicone rubber base, is 0.6 moles), 0.5 parts by mass of 2-phenyl-3-butyn-2-ol, and a 1,3-divinyltetramethyl disiloxane platinum complex (in an amount such that the platinum metal in this component is, in terms of mass units, 5 ppm in the dimethylpolysiloxane included in the silicone rubber base) were added to the silicone rubber base described above. Then, the mixture was mixed uniformly at room temperature. Thus, a thermally conductive silicone rubber composition was prepared. Characteristics of the thermally conductive silicone rubber composition and the thermally conductive silicone rubber are shown in Table 1.

### Practical Example 4

100 parts by mass of a dimethylpolysiloxane capped at both molecular terminals with dimethylvinylsiloxy groups having a viscosity at 25° C. of 400 mPa·s, 60 parts by mass of an aluminum oxide powder having an average particle size of 2 μm, 400 parts by mass of an aluminum hydroxide powder having an average particle size of 25 μm, and 10 parts by mass of methyl trimethoxysilane were premixed for 30 minutes at room temperature and, thereafter, heated/mixed at 150° C. for 60 minutes under reduced pressure. Then, the mixture was cooled to room temperature. Thus, a silicone rubber base was prepared.

Next, 13.0 parts by mass of a copolymer of dimethylsiloxane and methylhydrogensiloxane capped at both molecular terminals with trimethylsiloxy groups having a viscosity of 20 mPa·s (in an amount such that the amount of silicon-bonded hydrogen atoms in this component, per 1 mole of the vinyl groups in the dimethylpolysiloxane included in the silicone rubber base, is 0.7 moles), 0.5 parts by mass of 2-phenyl-3-butyn-2-ol, and a 1,3-divinyltetramethyl disiloxane platinum complex (in an amount such that the platinum metal in this component is, in terms of mass units, 5 ppm in the dimethylpolysiloxane included in the silicone rubber base) were added to the silicone rubber base described above. Then, the mixture was mixed uniformly at room temperature. Thus, a thermally conductive silicone rubber composition was prepared. Characteristics of the thermally conductive silicone rubber composition and the thermally conductive silicone rubber are shown in Table 1.

### Practical Example 5

100 parts by mass of a dimethylpolysiloxane capped at both molecular terminals with dimethylvinylsiloxy groups having a viscosity at 25° C. of 400 mPa·s, 50 parts by mass of an aluminum oxide powder having an average particle size of 2 μm, 190 parts by mass of an aluminum hydroxide powder having an average particle size of 35 μm, and 5 parts by mass of methyl trimethoxysilane were premixed for 30 minutes at room temperature and, thereafter, heated/mixed at 150° C. for 60 minutes under reduced pressure. Then, the mixture was cooled to room temperature. Thus, a silicone rubber base was prepared.

Next, 1.0 parts by mass of a copolymer of dimethylsiloxane and methylhydrogensiloxane capped at both molecular terminals with trimethylsiloxy groups having a viscosity of 5 mPa·s (in an amount such that the amount of silicon-bonded hydrogen atoms in this component, per 1 mole of the vinyl groups in the dimethylpolysiloxane included in the silicone rubber base, is 1.2 moles), 0.5 parts by mass of 2-phenyl-3-butyn-2-ol, and a 1,3-divinyltetramethyl disiloxane platinum complex (in an amount such that the platinum metal in this component is, in terms of mass units, 5 ppm in the dimethylpolysiloxane included in the silicone rubber base) were added to the silicone rubber base described above. Then, the mixture was mixed uniformly at room temperature. Thus, a thermally conductive silicone rubber composition was prepared. Characteristics of the thermally conductive silicone rubber composition and the thermally conductive silicone rubber are shown in Table 1.

### Practical Example 6

100 parts by mass of a dimethylpolysiloxane capped at both molecular terminals with dimethylvinylsiloxy groups having a viscosity at 25° C. of 400 mPa·s, 500 parts by mass of an aluminum oxide powder having an average particle size of 8 μm, 300 parts by mass of an aluminum hydroxide powder having an average particle size of 25 μm, and 10 parts by mass of methyl trimethoxysilane were premixed for 30 minutes at room temperature and, thereafter, heated/mixed at 150° C. for 60 minutes under reduced pressure. Then, the mixture was cooled to room temperature. Thus, a silicone rubber base was prepared.

Next, 1.0 parts by mass of a copolymer of dimethylsiloxane and methylhydrogensiloxane capped at both molecular terminals with trimethylsiloxy groups having a viscosity of 5 mPa·s, 4.0 parts by mass of a dimethylsiloxane capped at both molecular terminals with dimethylhydrogensiloxy groups having a viscosity of 10 mPa·s (in an amount such that the amount of silicon-bonded hydrogen atoms in this component, per 1 mole of the vinyl groups in the dimethylpolysiloxane included in the silicone rubber base, is 0.6 moles), 0.5 parts by mass of 2-phenyl-3-butyn-2-ol, and a 1,3-divinyltetramethyl disiloxane platinum complex (in an amount such that the platinum metal in this component is, in terms of mass units, 5 ppm in the dimethylpolysiloxane included in the silicone rubber base) were added to the silicone rubber base described above. Then, the mixture was mixed uniformly at room temperature. Thus, a thermally conductive silicone rubber composition was prepared. Characteristics of the thermally conductive silicone rubber composition and the thermally conductive silicone rubber are shown in Table 1.

### Comparative Example 1

100 parts by mass of a dimethylpolysiloxane capped at both molecular terminals with dimethylvinylsiloxy groups having a viscosity at 25° C. of 400 mPa·s, 80 parts by mass of an aluminum oxide powder having an average particle size of 2 μm, 200 parts by mass of an aluminum hydroxide powder having an average particle size of 2 μm, and 10 parts by mass of methyl trimethoxysilane were premixed for 30 minutes at room temperature and, thereafter, heated/mixed at 150° C. for 60 minutes under reduced pressure. Then, the mixture was cooled to room temperature. Thus, a thermally conductive silicone grease composition was prepared. Characteristics of this thermally conductive silicone grease composition are shown in Table 1.

### Comparative Example 2

100 parts by mass of a dimethylpolysiloxane capped at both molecular terminals with dimethylvinylsiloxy groups having a viscosity at 25° C. of 400 mPa·s, 600 parts by mass of an aluminum oxide powder having an average particle size of 8 μm, and 10 parts by mass of methyl trimethoxysilane were premixed for 30 minutes at room temperature and, thereafter, heated/mixed at 150° C. for 60 minutes under reduced pressure. Then, the mixture was cooled to room temperature. Thus, a silicone rubber base was prepared.

Next, 3.0 parts by mass of a copolymer of dimethylsiloxane and methylhydrogensiloxane capped at both molecular terminals with trimethylsiloxy groups having a viscosity of 5 mPa·s (in an amount such that the amount of silicon-bonded hydrogen atoms in this component, per 1 mole of the vinyl groups in the dimethylpolysiloxane included in the silicone rubber base, is 1.0 mole), 0.5 parts by mass of 2-phenyl-3-butyn-2-ol, and a 1,3-divinyltetramethyl disiloxane platinum complex (in an amount such that the platinum metal in this component is, in terms of mass units, 5 ppm in the dimethylpolysiloxane included in the silicone rubber base) were added to the silicone rubber base described above. Then, the mixture was mixed uniformly at room temperature. Thus, a thermally conductive silicone rubber composition was prepared. Characteristics of the thermally conductive silicone rubber composition and the thermally conductive silicone rubber are shown in Table 1.

### Comparative Example 3

100 parts by mass of a dimethylpolysiloxane capped at both molecular terminals with dimethylvinylsiloxy groups having a viscosity at 25° C. of 400 mPa·s, 60 parts by mass of an aluminum oxide powder having an average particle size of 8 μm, 60 parts by mass of an aluminum hydroxide powder having an average particle size of 2 μm, and 10 parts by mass of methyl trimethoxysilane were premixed for 30 minutes at room temperature and, thereafter, heated/mixed at 150° C. for 60 minutes under reduced pressure. Then, the mixture was cooled to room temperature. Thus, a silicone rubber base was prepared.

Next, 3.0 parts by mass of a copolymer of dimethylsiloxane and methylhydrogensiloxane capped at both molecular terminals with trimethylsiloxy groups having a viscosity of 5 mPa·s (in an amount such that the amount of silicon-bonded hydrogen atoms in this component, per 1 mole of the vinyl groups in the dimethylpolysiloxane included in the silicone rubber base, is 1.0 mole), 0.5 parts by mass of 2-phenyl-3-butyn-2-ol, and a 1,3-divinyltetramethyl disiloxane platinum complex (in an amount such that the platinum metal in this component is, in terms of mass units, 5 ppm in the dimethylpolysiloxane included in the silicone rubber base) were added to the silicone rubber base described above. Then, the mixture was mixed uniformly at room temperature. Thus, a thermally conductive silicone rubber composition was prepared. Characteristics of the thermally conductive silicone rubber composition and the thermally conductive silicone rubber are shown in Table 1.

TABLE 1

| Category | |
|---|---|
| | Comparative |
| Practical Examples | Examples |

| Item | 1 | 2 | 3 | 4 | 5 | 6 | 1 | 2 | 3 |
|---|---|---|---|---|---|---|---|---|---|
| Thix- | 1.5 | 1.3 | 1.4 | 1.3 | 1.2 | 1.8 | Did not | 1.8 | 4.0 |
| otropy | 1.5 | 1.5 | 1.2 | 1.9 | 1.5 | 1.8 | become | 2.0 | 0.5 |
| Thermal | | | | | | | paste- | | |
| conduc- | | | | | | | like | | |
| tivity | | | | | | | | | |
| (W/ | | | | | | | | | |
| m · K) | | | | | | | | | |
| Specific | 2.1 | 2.1 | 2.3 | 1.9 | 1.8 | 2.5 | | 2.7 | 1.5 |
| gravity | | | | | | | | | |
| (g/cm³) | | | | | | | | | |
| Hard- | — | 20 | 15 | 18 | 82 | 71 | | 95 | 45 |
| ness | | | | | | | | | |

### INDUSTRIAL APPLICABILITY

The thermally conductive silicone composition of the present invention has low thixotropy, low specific gravity, and high thermal conductivity and, therefore, is suitable as a heat dissipating material for use in a vehicle-mounted electronic component requiring light weight and/or requiring durability under elevated temperatures.

1. A thermally conductive silicone composition comprising:
(A) 100 parts by mass of an organopolysiloxane that is liquid at 25° C.;
(B) from 50 to 600 parts by mass of an aluminum oxide powder having an average particle size of not more than 10 μm; and
(C) from 100 to 500 parts by mass of an aluminum hydroxide powder having an average particle size of greater than 10 μm.

2. The thermally conductive silicone composition according to claim 1, wherein a viscosity at 25° C. of component (A) is from 100 to 1,000,000 mPa·s.

3. The thermally conductive silicone composition according to claim 1, wherein an average particle size of component (B) is from 1 to 8 μm.

4. The thermally conductive silicone composition according to claim 1, wherein an average particle size of component (C) is greater than 10 μm and not greater than 50 μm.

5. The thermally conductive silicone composition according to claim 1, further comprising: (D) an alkoxysilane in an amount of 1 to 100 parts by mass per 100 parts by mass of component (A).

6. The thermally conductive silicone composition according to claim 1, further comprising: (E) a silica-based filler in an amount of 1 to 50 parts by mass per 100 parts by mass of component (A).

7. The thermally conductive silicone composition according to claim 1, wherein component (A) is an organopolysiloxane having at least two alkenyl groups in a molecule; and the thermally conductive silicone composition further comprises: (F) an organopolysiloxane having at least two silicon-bonded hydrogen atoms in a molecule in an amount such that provides from 0.1 to 10 moles of silicon-bonded hydrogen atoms in component (F) per 1 mole of the alkenyl groups in component (A); and (G) a catalytic amount of a platinum-based catalyst.

8. The thermally conductive silicone composition according to claim 1, wherein a viscosity at 25° C. of component (A) is from 300 to 100,000 mPa·s.

9. The thermally conductive silicone composition according to claim 1, wherein a viscosity at 25° C. of component (A) is 400 mPa·s.

10. The thermally conductive silicone composition according to claim 1, wherein the molecular structure of component (A) is straight or partially branched straight.

11. The thermally conductive silicone composition according to claim 1, wherein the molecular structure of component (A) is a dendritic molecular structure.

12. A thermally conductive silicone composition comprising:
(A) 100 parts by mass of an organopolysiloxane that is liquid at 25° C.;
(B) from 50 to 600 parts by mass of an aluminum oxide powder having an average particle size of not more than 10 μm;
(C) from 100 to 400 parts by mass of an aluminum hydroxide powder having an average particle size of greater than 10 μm; and
(D) from 3 to 50 parts by mass of an alkoxysilane.

13. The thermally conductive silicone composition according to claim 12, wherein component (A) is an organopolysiloxane having at least two alkenyl groups in a molecule; and the thermally conductive silicone composition further comprises: (F) an organopolysiloxane having at least two silicon-bonded hydrogen atoms in a molecule in an amount such that provides from 0.5 to 5 moles of silicon-bonded hydrogen atoms in component (F) per 1 mole of the alkenyl groups in component (A); and (G) a catalytic amount of a platinum-based catalyst.
